(19) United States
(12) Patent Application Publication
(10) Pub. No.: US 2026/0121441 A1
(43) Pub. Date: Apr. 30, 2026

(54) HYBRID BATTERY SYSTEM INCLUDING SOLID-STATE HYDROGEN BATTERIES FOR LONG-TERM OUTAGES AND RECHARGEABLE BATTERIES FOR SHORT-TERM OUTAGES

(71) Applicant: Microsoft Technology Licensing, LLC, Redmond, WA (US)

(72) Inventors: Ehsan NASR AZADANI, Sammamish, WA (US); Sonia MALEKY, Newport Beach, CA (US); Sean JAMES, Olympia, WA (US)

(21) Appl. No.: 18/930,336

(22) Filed: Oct. 29, 2024

(51) Int. Cl. H02J 9/06; G06F 1/30; H01M 8/04082; H01M 8/10; H01M 10/34; H01M 10/48; H01M 10/615; H01M 10/627; H01M 10/6568; H01M 16/00; H01M 50/258

(52) U.S. Cl. CPC H02J 9/06; G06F 1/30; H01M 8/04201; H01M 10/345; H01M 10/482; H01M 10/615; H01M 10/627; H01M 10/6568; H01M 16/006; H01M 50/258; H01M 2008/1095; H01M 2220/10; H01M 2250/10; H01M 2250/402

(57) ABSTRACT

A hybrid battery system (HBS) for supplying power during long-term outages and short-term outages for a datacenter and related methods are described. An example HBS comprising a set of solid-state hydrogen batteries (SSHBs) and a set of rechargeable batteries (RBs) is configured to supply power to compute resources associated with a datacenter. The hybrid battery system is coupled to fuel cells to supply hydrogen to the fuel cells by heating an SSHB. A power control system is configured to: (1) during a short-term outage associated with the datacenter, selectively cause a subset of the set of RBs to supply power to the compute resources, and (2) during a long-term outage associated with the datacenter, selectively cause heat to be supplied to the set of SSHBs, resulting in a supply of hydrogen to one or more of the fuel cells, allowing supply of power to the compute resources.

### BACKGROUND

Datacenter deployment is accelerating in order to meet rising demand for computing, communication, and storage resources. However, efficient scaling of datacenter capacity is being constrained by the traditional architectures used for the distribution, delivery, and storage of energy. In addition, datacenters face issues related to outages associated with the grid being used to power the datacenters.

In order to meet high availability requirements, some datacenters use uninterruptible power supply (UPS) systems and diesel generators for handling grid power outage. UPS systems are typically based on traditional rechargeable batteries and therefore have limited life due to their inherent capacity loss because of the charging and discharging cycles. Moreover, diesel generators, which are used for standby power generation, operate at low efficiencies, require regular maintenance, and may negatively impact the environment because of the reliance on an external supply of diesel fuel.

Thus, there is a need for improved battery systems and methods associated with datacenters.

### SUMMARY

In one example, the present disclosure relates to a system comprising a hybrid battery system, including a set of solid-state hydrogen batteries and a set of rechargeable batteries, where the hybrid battery system is configured to supply power to compute resources associated with a datacenter. The system further includes a set of fuel cells coupled with the hybrid battery system, where a respective solid-state hydrogen battery from among the set of solid-state hydrogen batteries is configured to supply hydrogen to the set of fuel cells, when heat is supplied to the respective solid-state hydrogen battery.

The system further includes a power control system coupled to the hybrid battery system and the set of fuel cells. The power control system is configured to: (1) during a short-term outage associated with the datacenter, selectively cause a subset of the set of rechargeable batteries to supply power to the compute resources, and (2) during a long-term outage associated with the datacenter, selectively cause heat to be supplied to a first subset of the set of solid-state hydrogen batteries, resulting in the first subset of the set of solid-state hydrogen batteries supplying hydrogen to one or more of the set of fuel cells, allowing supply of power to the compute resources from the one or more of the set of fuel cells.

In another example, the present disclosure relates to a method for operating a system comprising: (1) a hybrid battery system including a set of solid-state hydrogen batteries and a set of rechargeable batteries, where the hybrid battery system is configured to supply power to compute resources associated with a datacenter, (2) a set of fuel cells coupled with the hybrid battery system, where a respective solid-state hydrogen battery from among the set of solid-state hydrogen batteries is configured to supply hydrogen to the set of fuel cells, when heat is supplied to the respective solid-state hydrogen battery.

The method includes during a short-term outage associated with the datacenter, selectively causing a subset of the set of rechargeable batteries to supply power to the compute resources. The method further includes during a long-term outage associated with the datacenter, selectively causing heat to be supplied to a first subset of the set of solid-state hydrogen batteries, resulting in the first subset of the set of solid-state hydrogen batteries supplying hydrogen to one or more of the set of fuel cells, thereby allowing supply of power to the compute resources from the one or more of the set of fuel cells.

In yet another example, the present disclosure relates to a system comprising a hybrid battery system, including a set of solid-state hydrogen batteries and a set of rechargeable batteries, where the hybrid battery system is to supply power to compute resources associated with a datacenter. The system further includes a set of fuel cells coupled with the hybrid battery system, where a respective solid-state hydrogen battery from among the set of solid-state hydrogen batteries is configured to supply hydrogen to the set of fuel cells, when heat is supplied to the respective solid-state hydrogen battery.

The system further includes a power control system coupled to the hybrid battery system and the set of fuel cells. The power control system is configured to, during a short-term outage associated with the datacenter, selectively cause a subset of the set of rechargeable batteries to supply power to the compute resources.

The power control system is further configured to, during a long-term outage with the datacenter: (1) selectively cause heat to be supplied to a first subset of the set of solid-state hydrogen batteries, resulting in the first subset of the set of solid-state hydrogen batteries supplying hydrogen to one or more of the set of fuel cells, allowing supply of power to the compute resources from the one or more of the set of fuel cells, (2) selectively cause heat produced by the one or more of the set of fuel cells and to flow to a first heat exchanger, (3) selectively cause waste heat produced by the datacenter to flow to the first heat exchanger, and (4) selectively cause the first heat exchanger to provide heat to the hybrid battery system to help heat the first subset of the set of solid-state hydrogen batteries.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 shows a system environment for a hybrid battery system in accordance with one example;

FIG. 2 shows a diagram of an example hybrid battery system arrangement including solid-state hydrogen batteries for long-term outages and rechargeable batteries for short-term outages;

FIG. 3 shows a diagram of various arrangements of solid-state hydrogen batteries coupled with fuel cells in accordance with one example;

FIG. 4 shows a diagram of a power control system for implementing aspects of the power control system of the system environment of FIG. 1;

FIG. 5 shows a diagram of a solid-state hydrogen storage arrangement and the extent of energy consumed during a long-term outage in accordance with one example;

FIG. 6 shows a diagram of solid-state hydrogen storage arrangement and the extent of energy consumed during two subsequent long-term outages in accordance with one example;

FIG. 7 shows a diagram of another example hybrid battery system arrangement including solid-state hydrogen batteries for long-term outages and rechargeable batteries for short-term outages;

FIG. 8 shows an ecosystem with a hybrid battery system and a datacenter that allows better use of resources associated with the datacenter; and

FIG. 9 shows a flowchart of a method associated with the system environment of FIG. 1 including a hybrid battery system in accordance with one example.

### DETAILED DESCRIPTION

Examples described in this disclosure relate to a hybrid battery system including solid-state hydrogen batteries for long-term outages and rechargeable batteries for short-term outages. As noted earlier, datacenter deployment is accelerating in order to meet rising demand for computing, communication, and storage resources. However, efficient scaling of datacenter capacity is being constrained by the traditional architectures used for the distribution, delivery, and storage of energy. In addition, datacenters face issues related to outages associated with the grid being used to power the datacenters. In order to meet high availability requirements, some datacenters use uninterruptible power supply (UPS) systems and diesel generators for handling grid power outage. UPS systems are typically based on traditional rechargeable batteries and therefore have limited life due to their inherent capacity loss because of the charging and discharging cycles. Moreover, diesel generators, which are used for standby power generation, operate at low efficiencies, require regular maintenance, and may negatively impact the environment because of the reliance on an external supply of diesel fuel. Accordingly, there is a need for better power systems in datacenters.

Examples described herein relate to a hybrid battery system including solid-state hydrogen batteries for long-term outages and rechargeable batteries for short-term outages. As used herein, the term “outage” means an interruption in the supply of power from a primary source of power (e.g., the grid) to compute resources within a datacenter. As used herein the term “long-term” outage means an outage of a duration of at least 4 hours up to 100 hours. As used herein the term “short-term” outage means an outage of a duration of up to 4 hours. As an example, in many instances, the short-term outage may relate to an outage of 2 hours to four hours.

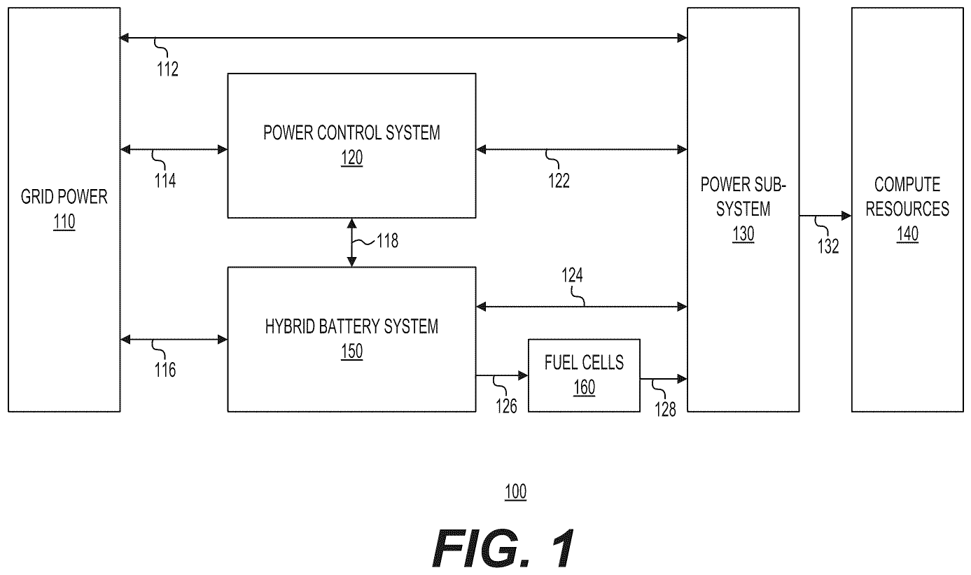

FIG. 1 shows a system environment 100 for a hybrid battery system 150 in accordance with one example. System environment 100 corresponds to a datacenter application in which grid power 110 powers compute resources 120 in non-outage conditions. Grid power 110 corresponds to electrical power obtained from any of various types of power generation sources, including hydroelectric power plants, renewable energy sources, nuclear power plants, or fossil-fuel energy sources. Grid power 110 is the primary source of power to compute resources 140 within a datacenter unless there is an outage. Grid power 110 is coupled via link 112 to a power sub-system 130, which in turn is coupled via link 132 to compute resources 140. Grid power 110 is further coupled via link 114 to a power control system 120, which in turn is coupled to the power sub-system 130 via link 122. Power control system 120 may include various control systems for controlling various components, and interactions among them, shown in FIG. 1. As used herein the term “link” includes, but is not limited to, one or more cables, pipes, and other types of connecting elements that may be used to establish a connection between two or more components. Such connections can be used to transfer electrical power, control signals, hydrogen fuel, or any other type of signals or materials (e.g., fuel or water using pipes) that need to be transferred between components connected via links. As used herein the term “pipe” includes, but is not limited to, any pipe structures, connectors, joints, or other pipe related elements that may be used to move any gas, air, any liquid, or water between at least two or more components.

Power sub-system 130 may include various components to enable interconnection between the power being supplied and compute resources 140 by allowing the management of variability in the type of power (AC vs. DC), the frequency (if AC), the voltage, and other variables associated with the power being received by power sub-system 130. As an example, power sub-system 130 can include components, such as inverters, solid-state transformers, or uninterruptible power supply (UPS) units. The selection and the enablement of these components can vary depending upon which aspects of the power supply components are implemented using the hybrid battery system 150.

With continued reference to FIG. 1, compute resources 140 may correspond to racks of servers interconnected via high-speed networks, including high-speed switches and routers. As an example, without limitation, compute resources 140 may include at least one of (or any appropriate combination of) a central-processing functionality, a graphics-processing functionality, an artificial-intelligence functionality, a gate-array functionality, a memory functionality, or a bus-interface-management functionality. Storage resources may comprise memory components, including any of non-volatile or volatile memory components. In certain examples, the methods and systems described herein may be deployed in cloud computing environments. Cloud computing may refer to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly. A cloud computing model can be composed of various characteristics such as, for example, on-demand self-service, broad network access, resource pooling, rapid elasticity, measured service, and so forth. A cloud computing model may be used to expose various service models, such as, for example, Hardware as a Service (“HaaS”), Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth.

System environment 100 further includes a hybrid battery system 150 coupled via link 116 to grid power 110. Hybrid battery system 150 is further coupled via link 118 to power control system 120. Hybrid battery system 150 is further coupled via link 124 to power sub-system 130. Hybrid battery system 150 is further coupled via link 126 to fuel cells 160. Fuel cells 160 are coupled via link 128 to the power sub-system 130. Hybrid battery system 150 includes solid-state hydrogen batteries for long-term outages and rechargeable batteries for short-term outages. Solid-state hydrogen batteries may include any batteries that store hydrogen as part of an alloy. Such solid-state hydrogen batteries are configured to release hydrogen when such batteries are heated. Examples of such solid-state hydrogen batteries include various types of metal hydrides. Examples of metal hydrides include lanthanum-nickel hydride, iron-titanium hydride, sodium-aluminum hydride (also referred to as sodium alanate), and similar other types of metal hydrides. As part of such solid-state hydrogen batteries, hydrogen is bonded with the respective metal alloy, and is released when the metal alloy is heated to a certain temperature. Rechargeable batteries may include any of the various types of chargeable electrical batteries, such as lithium-ion batteries. Other examples of rechargeable batteries include lead-acid batteries, nickel-cadmium batteries, lithium-iron phosphate batteries, and lithium-ion polymer batteries.

Power control system 120 can be implemented as a hierarchical control system, including top level control of the system that can receive inputs from a datacenter operator, including other types of automated control. Separate control systems that can be further controlled by the top level controller can include a controller for the solid-state hydrogen batteries, a controller for the rechargeable batteries, and various controllers for the power sub-system 130. As an example, there could be a separate controller for each of the various components of power sub-system 130, such as inverters, solid-state transformers, or uninterruptible power supply (UPS) units. As explained earlier, during long-term outages solid-state hydrogen batteries may be used to supply power to compute resources 140 and during short-term outages rechargeable batteries may be used to supply power to compute resources 140.

Still referring to FIG. 1, fuel cells 160 may be implemented as proton exchange membrane cells. In one example, fuel cells 160 may include one or more anodes and one or more cathodes arranged around an electrolyte. Hydrogen (obtained from the solid-state hydrogen batteries described as part of hybrid battery system 150) may be fed as fuel to the anode and air may be fed to the cathode. A catalyst at the anode may separate the hydrogen molecules into protons and electrons. The electrons may create the flow of electricity and thus provide power to compute resources 140. The protons may migrate through the electrolyte to the cathode and produce water and heat after combining with oxygen. Hydrogen from the solid-state hydrogen batteries may be vaporized using heat and then the warm gaseous hydrogen is fed to fuel cells 160 to generate power. Although FIG. 1 shows a certain number of components of system environment 100 arranged in a certain manner, there could be more or fewer number of components arranged differently.

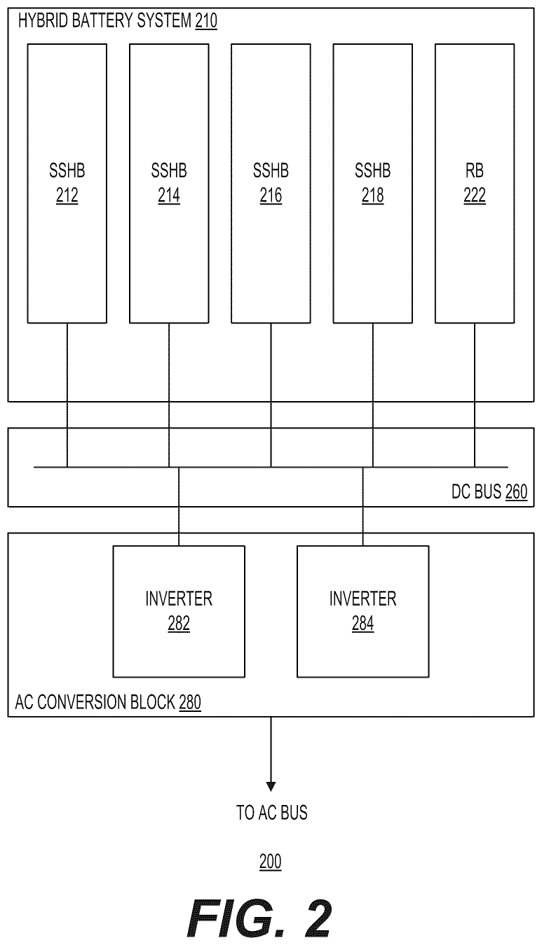

FIG. 2 shows a diagram of an example hybrid battery system arrangement 200 including solid-state hydrogen batteries for long-term outages and rechargeable batteries for short-term outages. Hybrid battery system arrangement 200 can be included as part of a primary cell subsystem of the datacenter, such that it can provide power to another subsystem (e.g., a hot-aisle containment (HAC) subsystem). In this example, hybrid battery system arrangement 200 comprises hybrid battery system 210, including solid-state hydrogen batteries and rechargeable batteries, which are coupled via a DC bus 260 to an AC conversion block 280. Hybrid battery system 210 includes an appropriate combination of solid-state hydrogen batteries and rechargeable batteries. Hybrid battery system 210 is shown with four solid-state hydrogen batteries (SSHBs), including SSHB 212, SSHB 214, SSHB 216, and SSHB 218. Hybrid battery system 210 is further shown with a rechargeable battery (RB) 222. The output of both the solid-state hydrogen batteries and the rechargeable battery is provided via a DC bus 260 to the AC conversion block 280. In this example, AC conversion block 280 includes two inverters (e.g., inverter 282 and inverter 284). In one example, AC conversion block 280 may be included as part of the power sub-system 130 of FIG. 1 described earlier. Although FIG. 2 shows a certain number of components of hybrid battery system arrangement 200 arranged in a certain manner, there could be more or fewer number of components arranged differently. As an example, although FIG. 2 shows a certain number of solid-state hydrogen batteries, additional or fewer such batteries could be included as part of the hybrid battery system arrangement 200.

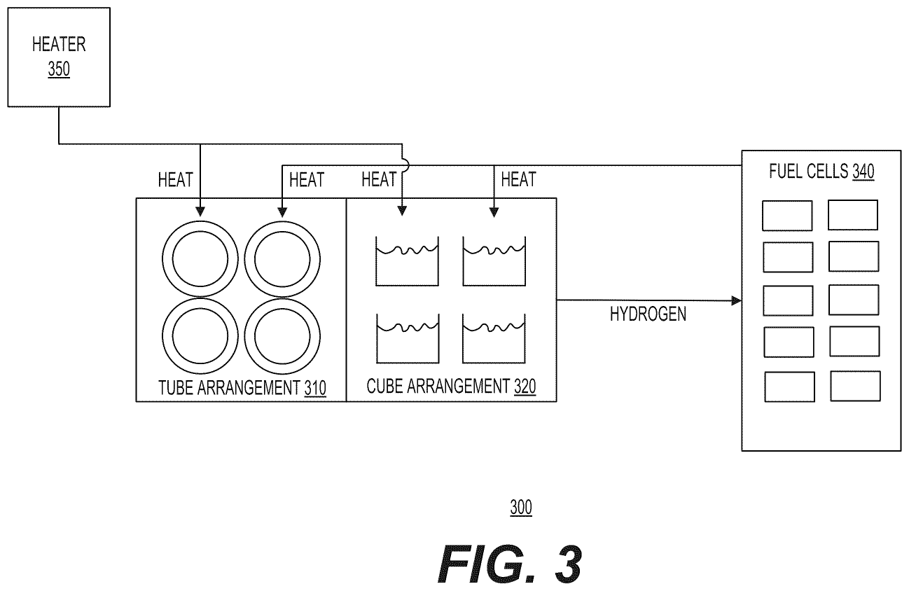

FIG. 3 shows a diagram of various arrangements 300 of solid-state hydrogen batteries coupled with fuel cells in accordance with one example. As explained earlier, solid-state hydrogen batteries may include any batteries that store hydrogen as part of an alloy. Such solid-state hydrogen batteries are configured to release hydrogen when such batteries are heated. The heat required to release hydrogen may be locally provided as part of the hydrogen storage or can be obtained from other sources, including hydrogen fuel cells, which consume hydrogen and generate water and heat as byproducts. As shown in FIG. 3, the solid-state hydrogen batteries may be stored in the form of tubes as part of a tube arrangement 310 or in the form of cubes as part of a cube arrangement 320. Other form factors may also be used. In this example, heat from fuel cells 340 is supplied to the solid-state hydrogen batteries, which generate hydrogen that is supplied to the fuel cells 340. The solid-state hydrogen batteries can also be heated using local heaters and/or other sources of heat. As an example, heat can be supplied from heater 350. Heater 350 can be included as part of the storage for the solid-state hydrogen batteries or can be external to the storage. Advantageously, the use of solid-state hydrogen batteries reduces the footprint for hydrogen storage significantly (e.g., as much as ten-times reduction) compared with the footprint for hydrogen storage as part of a compressed gaseous hydrogen system.

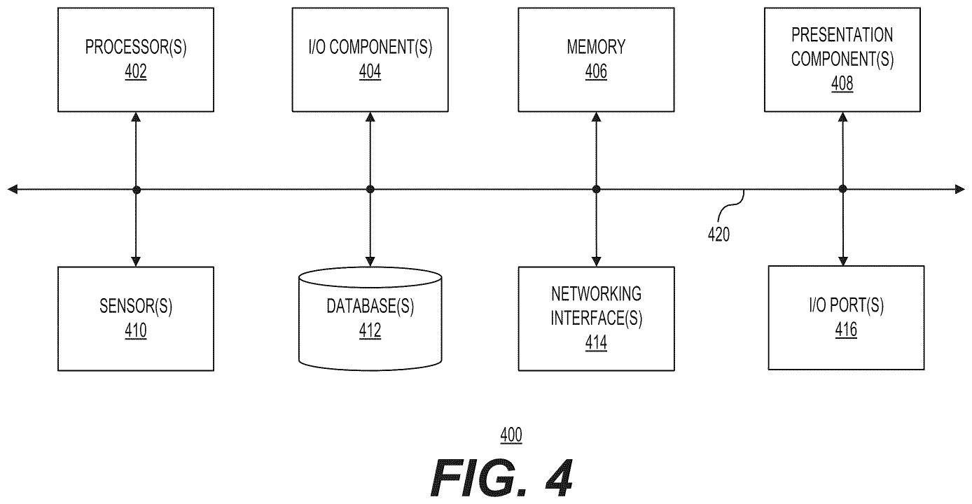

FIG. 4 shows a diagram of a power control system 400 for implementing aspects of power control system 120 of the system environment 100 of FIG. 1. As an example, power control system 400 may be used to implement various control actions associated with sensing and controlling components associated with delivering power, movement of hydrogen, and transfer of heat, as needed. Power control system 400 may further be used to manage the hybrid battery system, including controlling which type of batteries are being used depending upon whether there is a long-term outage or a short-term outage. Power control system 400 includes a processor(s) 402, I/O component(s) 404, memory 406, presentation component(s) 408, sensors 410, database(s) 412, networking interface(s) 414, and I/O port(s) 416, which may be interconnected via bus 420. Processor(s) 402 may execute instructions stored in memory 406. Processor(s) 402 may include CPUs, GPUs, ASICs, FPGAS, controllers, or other types of logic configured to execute instructions (firmware or software). I/O component(s) 404 may include components such as a keyboard, a mouse, a voice recognition processor, or touch screens. Memory 406 may be any combination of non-volatile storage or volatile storage (e.g., flash memory, DRAM, SRAM, or other types of memories).

Presentation component(s) 408 may include displays, holographic devices, or other presentation devices. Displays may be any type of display, such as LCD, LED, or other types of display. Sensor(s) 410 may include telemetry or other types of sensors configured to detect and/or receive information (e.g., conditions associated with the various devices in a datacenter). Sensor(s) 410 may include sensors configured to monitor conditions associated with the various components associated with system environment 100 of FIG. 1. As an example, sensors 410 may include pressure sensors, temperature sensors, flow sensors, voltage sensors, current sensors, and other sensors needed to operate the various aspects of systems and components shown as part of system environment 100 of FIG. 1, including hybrid battery system 150 of FIG. 1, in a safe and efficient manner.

Still referring to FIG. 4, database(s) 412 may be used to store any of the data or files as needed for the performance of methods described herein. Database(s) 412 may be implemented as a collection of distributed databases or as a single database. Network interface(s) 414 may include communication interfaces, such as Ethernet, cellular radio, Bluetooth radio, UWB radio, or other types of wireless or wired communication interfaces. I/O port(s) 416 may include Ethernet ports, Fiber-optic ports, wireless ports, or other communication ports.

Instructions corresponding to various control and management aspects of hybrid battery system 150 and other aspects of the components and sub-systems shown as part of system environment 100 of FIG. 1 may be stored in memory 406 or another memory. These instructions, when executed by processor(s) 402, or other processors and controllers, may provide at least some of the control and management functionality associated with the hybrid battery system 150 of FIG. 1. The instructions corresponding to control and monitoring aspects associated with the components shown as part of system environment 100 of FIG. 1, and related components, could be encoded as hardware or software. The functionality associated with power control system 400 may be implemented using any appropriate combination of hardware, software, or firmware. Although FIG. 4 shows power control system 400 as including a certain number of components arranged and coupled in a certain way, it may include fewer or additional components arranged and coupled differently. In addition, the functionality associated with power control system 400 may be distributed or combined, as needed.

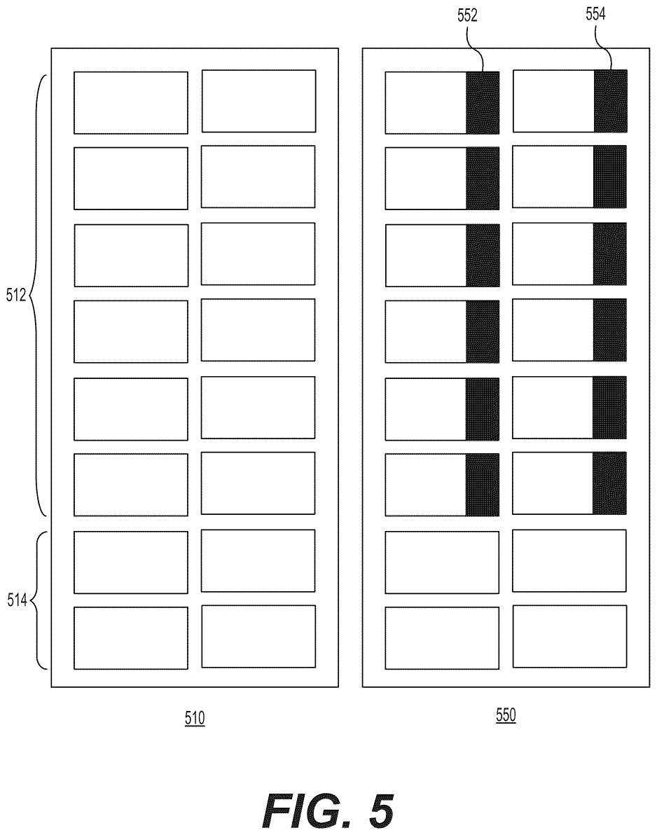

FIG. 5 shows a diagram of solid-state hydrogen storage arrangement 510 and the extent of energy consumed during a long-term outage in accordance with one example. As explained earlier, during a long-term outage the hybrid battery system includes solid-state hydrogen batteries for powering the compute resources and other aspects of a datacenter. As part of provisioning the solid-state hydrogen batteries, one can factor the power requirements of the datacenter, including the degree of utilization of the compute resources. This is because in many instances, the compute resources may be underutilized, requiring only about 75 percent or less of the power available to them. As an example, one were to provision 1 megawatt of power for a datacenter, the compute resources may utilize only 750 kilowatts during normal operating conditions. In addition, in this example, it is assumed that as part of the hybrid battery system, the solid-state hydrogen batteries are not rechargeable at the datacenter itself and require mechanical replacement of the batteries installed in the storage racks. To ensure enough margin for such maintenance and refueling, a certain number of solid-state hydrogen batteries can be reserved. As an example, FIG. 5 shows a solid-state hydrogen battery (SSHB) storage arrangement 510 with sixteen compartments for solid-state hydrogen batteries. Out of the sixteen storage racks, twelve storage racks 512 of solid-state hydrogen batteries are allocated for use during the long-term outage. Four storage racks 514 out of the sixteen storage racks are allocated to solid-state hydrogen batteries for use as a backup during maintenance and refueling.

As part of arrangement 510, each of the solid-state hydrogen batteries are assumed to be fully charged. Arrangement 550 shows the state of the solid-state hydrogen batteries after a first long-term outage experienced by the datacenter. The extent of the hydrogen depleted during the long-term outage is shown by shaded areas 552 and 554. A control system, such as the power control system 400 of FIG. 4, can be used to track an indication of the amount of remaining charge that each solid-state hydrogen battery could produce at a given time. The control system can provide an indication to an operator of the datacenter when the amount of the remaining charge reaches or falls below a threshold amount. Since the solid-state hydrogen batteries are arranged in a modular fashion as part of storage racks, each one of the set of solid-state hydrogen batteries can be individually replaced once an indication of an amount of remaining charge reaches or falls below the threshold amount. In addition, depending on the needs of different datacenters, a different number of storage racks can be provided for use with the solid-state hydrogen batteries. By incorporating the predicted load on the backup power required during a long-term outage, an appropriate number of solid-state hydrogen battery racks can be commissioned. At the same time, during high load situations, the rechargeable batteries can also be deployed at the same time as the solid-state hydrogen batteries. Although FIG. 5 shows a certain number and arrangement of storage racks, a different number of storage racks that are arranged differently may also be used.

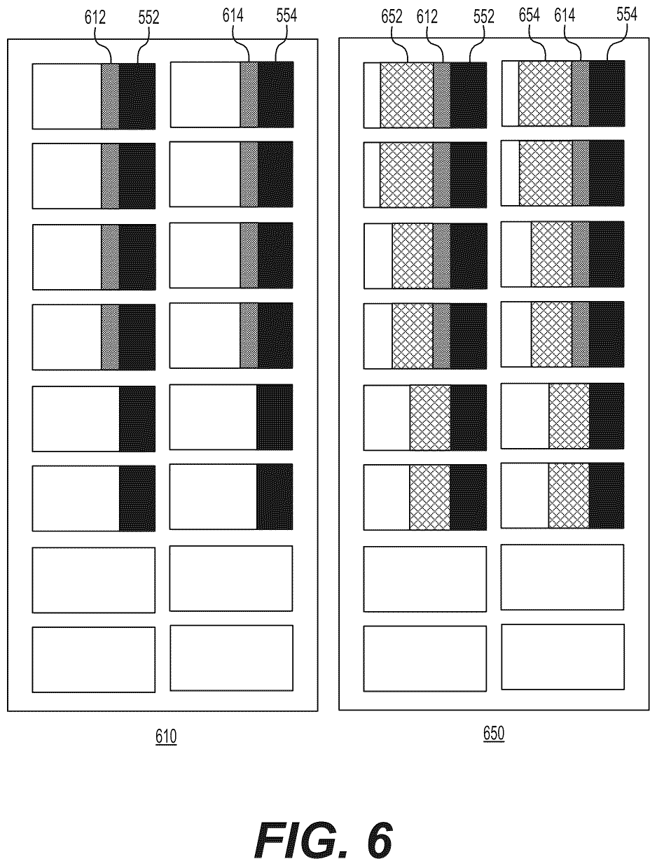

FIG. 6 shows a diagram of a solid-state hydrogen storage arrangement and the extent of energy consumed during two subsequent long-term outages in accordance with one example. The same or similar components or aspects that are shown in FIG. 6 are referred to using the same reference numbers as used in FIG. 5. Arrangement 610 shows the state of the solid-state hydrogen batteries after a second long-term outage experienced by the datacenter. The extent of the hydrogen depleted during the first long-term outage is shown by shaded areas 552 and 554 and the extent of the hydrogen depleted during the second long-term outage is shown by shaded areas 612 and 614. Arrangement 650 shows the state of the solid-state hydrogen batteries after a third long-term outage experienced by the datacenter. The extent of the hydrogen depleted during the first long-term outage is shown by shaded areas 552 and 554, the extent of the hydrogen depleted during the second long-term outage is shown by shaded areas 612 and 614, and the extent of the hydrogen depleted during the third long-term outage is shown by shaded areas 652 and 654. In one example, once the hydrogen has been depleted by a certain extent (e.g., 90 percent), mechanical replacement of the respective solid-state hydrogen battery may be required.

With continued reference to FIGS. 5 and 6, in one example, the replacement of the solid-state hydrogen batteries may be performed during a time when the load on the power system is predicted to be low. As an example, the power control system (e.g., power control system 400 of FIG. 4) can have trained machine language (ML) models based on data related to the historical usage of the compute resources in the datacenter. As an example, neural network models can be trained using stochastic gradient descent type of techniques. These models can be trained based on telemetry data associated with the historical power usage by the compute resources within the datacenter. Machine learning models can then be trained to predict time periods during which the usage of the compute resources within the datacenter is going to be lower than usual. During such predicted time periods, maintenance of the solid-state hydrogen batteries can be scheduled. As an example, other types of ML models, including Bayesian models, may be used. In general, one may implement a supervised learning algorithm that can be trained based on input data and once it is trained it can make predictions or prescriptions based on the training. Any of the learning and inference techniques such as Linear Regression, Support Vector Machine (SVM) set up for regression, Random Forest set up for regression, Gradient-boosting trees set up for regression and neural networks may be used. Linear regression may include modeling the past relationship between independent variables and dependent output variables. Neural networks may include artificial neurons used to create an input layer, one or more hidden layers, and an output layer. Each layer may be encoded as matrices or vectors of weights expressed in the form of coefficients or constants that might have been obtained via off-line training of the neural network. Neural networks may be implemented as Recurrent Neural Networks (RNNs), Long Short Term Memory (LSTM) neural networks, or Gated Recurrent Unit (GRUs). All of the information required by a supervised learning-based model may be translated into vector representations corresponding to any of these techniques.

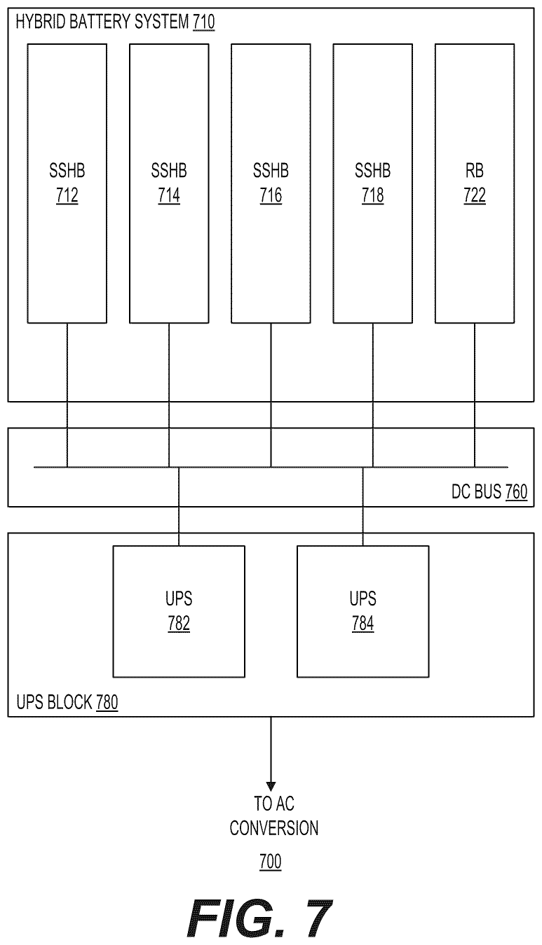

FIG. 7 shows a diagram of another example hybrid battery system arrangement 700 including solid-state hydrogen batteries for long-term outages and rechargeable batteries for short-term outages. Hybrid battery system arrangement 700 can be included as part of a primary cell subsystem of the datacenter, such that it can provide power to another subsystem (e.g., a hot-aisle containment (HAC) subsystem). In this example, hybrid battery system arrangement 700 includes hybrid battery system 710 including solid-state hydrogen batteries and rechargeable batteries, which are coupled via a DC bus 760 to an uninterruptible power supply (UPS) block 780. Hybrid battery system 710 includes an appropriate combination of solid-state hydrogen batteries and rechargeable batteries. Hybrid battery system 710 is shown with four solid-state hydrogen batteries (SSHBs), including SSHB 712, SSHB 714, SSHB 716, and SSHB 718. Hybrid battery system 710 is further shown with a rechargeable battery (RB) 722. The output of both the solid-state hydrogen batteries and the rechargeable battery is provided via a DC bus 760 to the UPS block 780. In this example, UPS block 780 includes two uninterruptible power supplies (e.g., UPS 782 and UPS 784). In one example, UPS block 780 may be included as part of the power sub-system 130 of FIG. 1 described earlier. Although FIG. 7 shows a certain number of components of hybrid battery system arrangement 700 arranged in a certain manner, there could be more or fewer number of components arranged differently. As an example, although FIG. 7 shows a certain number of solid-state hydrogen batteries, additional or fewer such batteries could be included as part of the hybrid battery system arrangement 700.

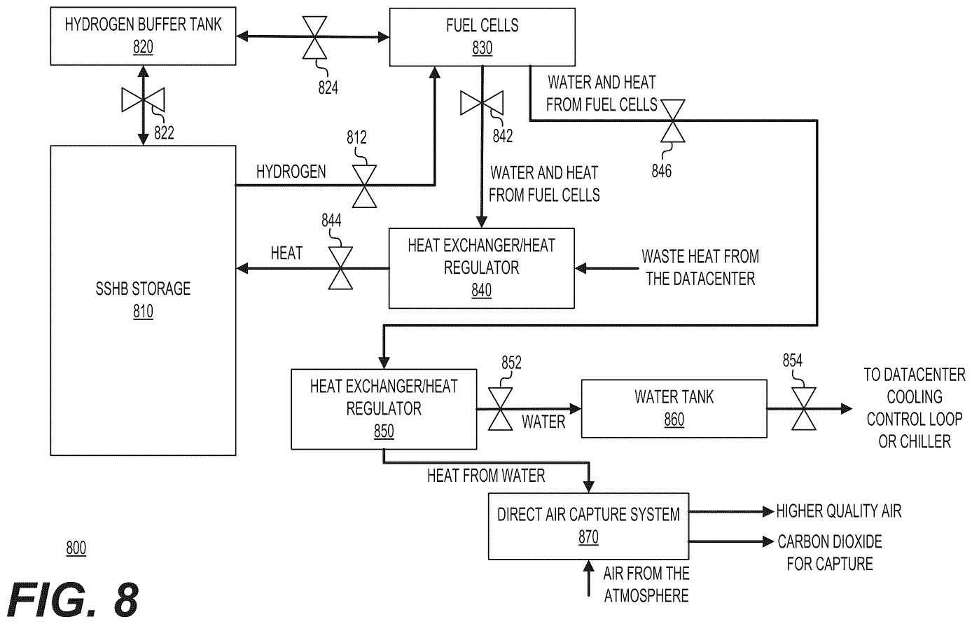

FIG. 8 shows an ecosystem 800 with a solid-state hydrogen battery (SSHB) storage 810 and the datacenter that allows better use of resources associated with the datacenter. In this example, SSHB storage can include any of the SSHBs described earlier. Ecosystem 800 includes fuel cells 830 coupled to the SSHB storage 810. As explained earlier, SSHB storage 810 includes solid-state hydrogen batteries for long-term outages. Solid-state hydrogen batteries may include any batteries that store hydrogen as part of an alloy. Such solid-state hydrogen batteries are configured to release hydrogen when such batteries are heated. The released hydrogen is provided to fuel cells 830 (similar to fuel cells 160 of FIG. 1). A valve 812 can be used to control the flow of hydrogen to fuel cells 830. A hydrogen buffer tank 820 is shown coupled to both SSHB storage 810 and fuel cells 830. Another valve 822 can be used to regulate the flow of hydrogen between SSHB storage 810 and hydrogen buffer tank 820. Yet another valve 824 can be used to regulate the flow of hydrogen between fuel cells 830 and hydrogen buffer tank 820.

As explained earlier, fuel cells 830 can include one or more anodes and one or more cathodes arranged around an electrolyte. Hydrogen (obtained from the solid-state hydrogen batteries included as part of SSHB storage 810) is fed as fuel to the anode and air is fed to the cathode. A catalyst at the anode may separate the hydrogen molecules into protons and electrons. The electrons create the flow of electricity and thus provide DC power to the datacenter. The protons migrate through the electrolyte to the cathode and produce water and heat after combining with oxygen. The water and heat produced by fuel cells 830 is channeled to a heat exchanger/heat regulator 840. A valve 842 can be used to control the flow of the water and heat from fuel cells 830 to heat exchanger/heat regulator 840. Waste heat from the datacenter can also be supplied to heat exchanger/heat regulator 840. Waste heat is the heat generated by the operation of the datacenter, and it would have been wasted otherwise. Heat can then be provided to the SSHB storage 810 to help in heating the solid-state hydrogen batteries therein. A valve 844 can be used to control the flow of such heat. Although not shown in FIG. 8, solid-state hydrogen batteries as part of SSHB storage 810 can also be heated using other heaters.

With continued reference to FIG. 8, water and heat output from the fuel cells 830 can also be provided to a heat exchanger/heat regulator 850 via a valve 846. The cooler water output by heat exchanger/heat regulator 850 is coupled to a water tank 860. The inflow of the water into water tank 860 can be controlled using a valve 852. Cooled water from the water tank 860 can be provided to the datacenter cooling system (e.g., a chiller based cooling system or an adiabatic cooling system). Thus, the cooled water, depending upon its temperature, can be directly provided to the datacenter cooling loop or provided to a chiller for additional cooling before its use. Another valve 854 can be used to control the outflow of such water. Moreover, the heat from the heat exchanger/heat regulator 850 can be coupled with a direct air capture system 870, which can take air from the atmosphere and output higher quality air by allowing capture of the carbon dioxide.

Still referring to FIG. 8, ecosystem 800 can also be used to enable grid services, including providing excess power to the grid. During a planned or an unplanned outage, such grid services can be disabled. Moreover, at times, the SSHB storage 810 can be configured to supply excess hydrogen to the hydrogen buffer tank 820. The heat generated by fuel cells 830 can be used to enable direct air capture to reduce the cardon dioxide emissions from the datacenter. Thus, in sum, ecosystem 800, including the SSHB storage 810, can be used to ensure compliance with sustainability goals during times when there is an outage. Although FIG. 8 shows a certain number of components of ecosystem 800 arranged in a certain manner, there could be more or fewer number of components arranged differently.

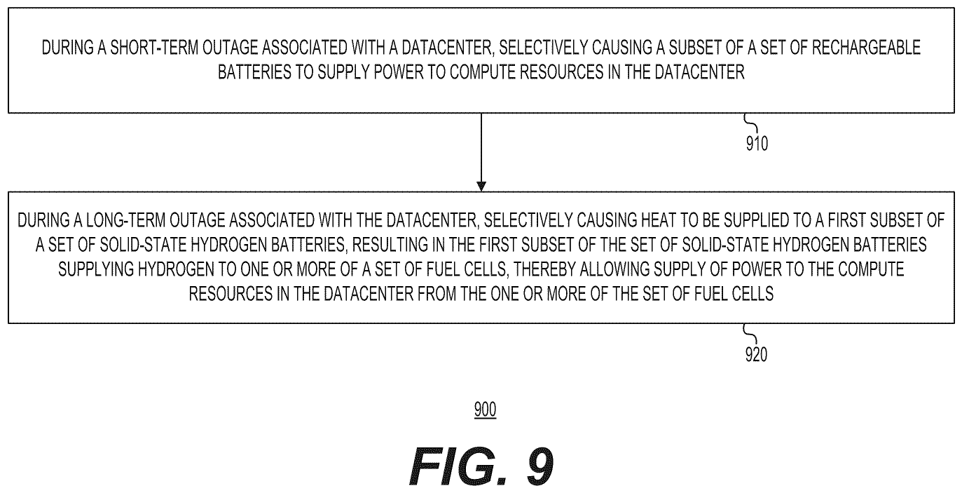

FIG. 9 shows a flowchart 900 of a method associated with system environment 100 of FIG. 1 including a hybrid battery system in accordance with one example. The various steps shown as part of flowchart 900 may be executed by instructions associated with power control system 120 of FIG. 1 (further explained in FIG. 4) described earlier. This method relates to operating a system comprising: (1) a hybrid battery system including a set of solid-state hydrogen batteries and a set of rechargeable batteries, where the hybrid battery system is configured to supply power to compute resources associated with a datacenter, (2) a set of fuel cells coupled with the hybrid battery system, where a respective solid-state hydrogen battery from among the set of solid-state hydrogen batteries is configured to supply hydrogen to the set of fuel cells, when heat is supplied to the respective solid-state hydrogen battery. Step 910 includes, during a short-term outage associated with the datacenter, selectively causing a subset of the set of rechargeable batteries to supply power to the compute resources. As explained earlier, instructions corresponding to various control and management aspects of the hybrid battery system (e.g., hybrid battery system 150 of FIG. 1) can be stored in a memory (e.g., memory 406 of FIG. 4). These instructions when executed by a processor (e.g., processor(s) 402 of FIG. 4) can be used to determine whether outage corresponds to a short-term outage. This determination can be automatically made by the power control system when the outage does not last beyond the duration of time defined as the short-term outage. In addition, in some instances prediction systems associated with the power control system (e.g., power control system 400 of FIG. 4) can also be used in predicting or assisting in determining whether the outage is a short-term outage or a long-term outage. During the short-term outage, rechargeable batteries (e.g., RB 222 of FIG. 2 or RB 772 of FIG. 7) can supply power to the compute resources in the datacenter (e.g., compute resources 140 of FIG. 1).

Step 920 includes, during a long-term outage associated with the datacenter, selectively causing heat to be supplied to a first subset of the set of solid-state hydrogen batteries, resulting in the first subset of the set of solid-state hydrogen batteries supplying hydrogen to one or more of the set of fuel cells, thereby allowing supply of power to the compute resources in the datacenter from the one or more of the set of fuel cells. As explained earlier, instructions corresponding to various control and management aspects of the hybrid battery system (e.g., hybrid battery system 150 of FIG. 1) can be stored in a memory (e.g., memory 406 of FIG. 4). These instructions when executed by a processor (e.g., processor(s) 402 of FIG. 4) can be used to determine whether outage corresponds to a long-term outage. This determination can be automatically made by the power control system when the outage extends beyond the duration of time defined as the long-term outage. In addition, in some instances prediction systems associated with the power control system (e.g., power control system 400 of FIG. 4) can also be used in predicting or assisting in determining whether the outage is a short-term outage or a long-term outage.

During the long-term outage, one or more of the solid-state hydrogen batteries (e.g., SSHB 212, SSHB 214, SSHB 216, and SSHB 218 of FIG. 2 or SSHB 712, SSHB 714, SSHB 716, and SSHB 718 of FIG. 7) can supply heat to one or more of the fuel cells (e.g., fuel cells 160 of FIG. 1), which in turn can supply power to the compute resources in the datacenter (e.g., compute resources 140 of FIG. 1). As explained earlier, solid-state hydrogen batteries may include any batteries that store hydrogen as part of an alloy. Such solid-state hydrogen batteries are configured to release hydrogen when such batteries are heated. Moreover, as explained earlier, hydrogen (obtained from the solid-state hydrogen batteries described as part of hybrid battery system 150 of FIG. 1) may be fed as fuel to the anode and air may be fed to the cathode. A catalyst at the anode may separate the hydrogen molecules into protons and electrons. The electrons may create the flow of electricity and thus provide DC power to compute resources 140 of FIG. 1. Other types of fuel cells that use hydrogen as a fuel may also be used.

In conclusion, in one example, the present disclosure relates to a system comprising a hybrid battery system, including a set of solid-state hydrogen batteries and a set of rechargeable batteries, where the hybrid battery system is configured to supply power to compute resources associated with a datacenter. The system further includes a set of fuel cells coupled with the hybrid battery system, where a respective solid-state hydrogen battery from among the set of solid-state hydrogen batteries is configured to supply hydrogen to the set of fuel cells, when heat is supplied to the respective solid-state hydrogen battery.

The system further includes a power control system coupled to the hybrid battery system and the set of fuel cells. The power control system is configured to: (1) during a short-term outage associated with the datacenter, selectively cause a subset of the set of rechargeable batteries to supply power to the compute resources, and (2) during a long-term outage associated with the datacenter, selectively cause heat to be supplied to a first subset of the set of solid-state hydrogen batteries, resulting in the first subset of the set of solid-state hydrogen batteries supplying hydrogen to one or more of the set of fuel cells, allowing supply of power to the compute resources from the one or more of the set of fuel cells.

The set of solid-state hydrogen batteries can be arranged in a modular fashion as part of storage racks such that each one of the set of solid-state hydrogen batteries can be individually replaced once an indication of an amount of remaining charge reaches or falls below a threshold amount. As part of the system, only the first subset of the set of solid-state hydrogen batteries is configured to supply hydrogen during the long-term outage, and a second subset of the set of solid-state hydrogen batteries is reserved for use during maintenance of the first subset of the set of solid-state hydrogen batteries.

Each of the set of solid-state hydrogen batteries may comprise a metal hydride. The metal hydride may comprise one of lanthanum-nickel hydride, iron-titanium hydride, or sodium-aluminum hydride. Each of the set of solid-state hydrogen batteries may comprise hydrogen atoms bonded to a metal alloy.

In one example, the power control system is configured to predict utilization load of the compute resources to allow for maintenance associated with the set of solid-state hydrogen batteries during time periods associated with a lower predicted utilization load of the computer resources in the datacenter.

In another example, the present disclosure relates to a method for operating a system comprising: (1) a hybrid battery system including a set of solid-state hydrogen batteries and a set of rechargeable batteries, where the hybrid battery system is configured to supply power to compute resources associated with a datacenter, (2) a set of fuel cells coupled with the hybrid battery system, where a respective solid-state hydrogen battery from among the set of solid-state hydrogen batteries is configured to supply hydrogen to the set of fuel cells, when heat is supplied to the respective solid-state hydrogen battery.

The method includes during a short-term outage associated with the datacenter, selectively causing a subset of the set of rechargeable batteries to supply power to the compute resources. The method further includes during a long-term outage associated with the datacenter, selectively causing heat to be supplied to a first subset of the set of solid-state hydrogen batteries, resulting in the first subset of the set of solid-state hydrogen batteries supplying hydrogen to one or more of the set of fuel cells, thereby allowing supply of power to the compute resources from the one or more of the set of fuel cells.

The set of solid-state hydrogen batteries can be arranged in a modular fashion in storage racks such that each one of the set of solid-state hydrogen batteries can be individually replaced once an indication of an amount of remaining charge reaches or falls below a threshold amount. As part of this system, only the first subset of the set of solid-state hydrogen batteries is configured to supply hydrogen during the long-term outage, and a second subset of the set of solid-state hydrogen batteries is reserved for use during maintenance of the first subset of the set of solid-state hydrogen batteries.

Each of the set of solid-state hydrogen batteries may comprise a metal hydride. The metal hydride may comprise one of lanthanum-nickel hydride, iron-titanium hydride, or sodium-aluminum hydride. Each of the set of solid-state hydrogen batteries may comprise hydrogen atoms bonded to a metal alloy.

In yet another example, the present disclosure relates to a system comprising a hybrid battery system, including a set of solid-state hydrogen batteries and a set of rechargeable batteries, where the hybrid battery system is to supply power to compute resources associated with a datacenter. The system further includes a set of fuel cells coupled with the hybrid battery system, where a respective solid-state hydrogen battery from among the set of solid-state hydrogen batteries is configured to supply hydrogen to the set of fuel cells, when heat is supplied to the respective solid-state hydrogen battery.

The system further includes a power control system coupled to the hybrid battery system and the set of fuel cells. The power control system is configured to, during a short-term outage associated with the datacenter, selectively cause a subset of the set of rechargeable batteries to supply power to the compute resources.

The power control system is further configured to, during a long-term outage with the datacenter: (1) selectively cause heat to be supplied to a first subset of the set of solid-state hydrogen batteries, resulting in the first subset of the set of solid-state hydrogen batteries supplying hydrogen to one or more of the set of fuel cells, allowing supply of power to the compute resources from the one or more of the set of fuel cells, (2) selectively cause heat produced by the one or more of the set of fuel cells and to flow to a first heat exchanger, (3) selectively cause waste heat produced by the datacenter to flow to the first heat exchanger, and (4) selectively cause the first heat exchanger to provide heat to the hybrid battery system to help heat the first subset of the set of solid-state hydrogen batteries.

The power control system may further be configured to: (1) selectively cause heated water to flow from the one or more of the set of fuel cells to a second heat exchanger, (2) selectively cause the second heat exchanger to provide cooled water for use with a cooling system associated with the datacenter, and (3) selectively cause the second heat exchanger to provide heat to a direct air capture system. The power control system may also be configured to predict utilization load of the compute resources to allow for maintenance associated with the set of solid-state hydrogen batteries during time periods associated with a lower predicted utilization load of the computer resources in the datacenter.

As part of the system, only the first subset of the set of solid-state hydrogen batteries is configured to supply hydrogen during the long-term outage, and a second subset of the set of solid-state hydrogen batteries is reserved for use during maintenance of the first subset of the set of solid-state hydrogen batteries. Each of the set of solid-state hydrogen batteries may comprise a metal hydride. The metal hydride may comprise one of lanthanum-nickel hydride, iron-titanium hydride, or sodium-aluminum hydride. Each of the set of solid-state hydrogen batteries may comprise hydrogen atoms bonded to a metal alloy.

It is to be understood that the methods, modules, and components depicted herein are merely exemplary. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), or Complex Programmable Logic Devices (CPLDs). In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, or the component B may be a sub-component of the component A.

The functionality associated with some examples described in this disclosure can also include instructions stored in a non-transitory media. The term “non-transitory media” as used herein refers to any media storing data and/or instructions that cause a machine to operate in a specific manner.

Exemplary non-transitory media include non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Exemplary transmission media, include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a”or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

1. A system comprising:
a hybrid battery system including a set of solid-state hydrogen batteries and a set of rechargeable batteries, wherein the hybrid battery system is to supply power to compute resources associated with a datacenter;
a set of fuel cells coupled with the hybrid battery system, wherein a respective solid-state hydrogen battery from among the set of solid-state hydrogen batteries is configured to supply hydrogen to the set of fuel cells, when heat is supplied to the respective solid-state hydrogen battery; and
a power control system, coupled to the hybrid battery system and the set of fuel cells, wherein the power control system is configured to:
during a short-term outage associated with the datacenter, selectively cause a subset of the set of rechargeable batteries to supply power to the compute resources, and
during a long-term outage associated with the datacenter, selectively cause heat to be supplied to a first subset of the set of solid-state hydrogen batteries, resulting in the first subset of the set of solid-state hydrogen batteries supplying hydrogen to one or more of the set of fuel cells, allowing supply of power to the compute resources from the one or more of the set of fuel cells.

2. The system of claim 1, wherein the set of solid-state hydrogen batteries are arranged in a modular fashion as part of storage racks such that each one of the set of solid-state hydrogen batteries can be individually replaced once an indication of an amount of remaining charge reaches or falls below a threshold amount.

3. The system of claim 2, wherein only the first subset of the set of solid-state hydrogen batteries is configured to supply hydrogen during the long-term outage, and wherein a second subset of the set of solid-state hydrogen batteries is reserved for use during maintenance of the first subset of the set of solid-state hydrogen batteries.

4. The system of claim 1, wherein each of the set of solid-state hydrogen batteries comprises a metal hydride.

5. The system of claim 4, wherein the metal hydride comprises one of lanthanum-nickel hydride, iron-titanium hydride, or sodium-aluminum hydride.

6. The system of claim 1, wherein each of the set of solid-state hydrogen batteries comprises hydrogen atoms bonded to a metal alloy.

7. The system of claim 1, wherein the power control system is configured to predict utilization load of the compute resources to allow for maintenance associated with the set of solid-state hydrogen batteries during time periods associated with a lower predicted utilization load of the computer resources in the datacenter.

8. A method for operating a system comprising: (1) a hybrid battery system including a set of solid-state hydrogen batteries and a set of rechargeable batteries, wherein the hybrid battery system is configured to supply power to compute resources associated with a datacenter, (2) a set of fuel cells coupled with the hybrid battery system, wherein a respective solid-state hydrogen battery from among the set of solid-state hydrogen batteries is configured to supply hydrogen to the set of fuel cells, when heat is supplied to the respective solid-state hydrogen battery, the method comprising:
during a short-term outage associated with the datacenter, selectively causing a subset of the set of rechargeable batteries to supply power to the compute resources; and
during a long-term outage associated with the datacenter, selectively causing heat to be supplied to a first subset of the set of solid-state hydrogen batteries, resulting in the first subset of the set of solid-state hydrogen batteries supplying hydrogen to one or more of the set of fuel cells, thereby allowing supply of power to the compute resources from the one or more of the set of fuel cells.

9. The method of claim 8, wherein the set of solid-state hydrogen batteries are arranged in a modular fashion in storage racks such that each one of the set of solid-state hydrogen batteries can be individually replaced once an indication of an amount of remaining charge reaches or falls below a threshold amount.

10. The method of claim 9, wherein only the first subset of the set of solid-state hydrogen batteries is configured to supply hydrogen during the long-term outage, and wherein a second subset of the set of solid-state hydrogen batteries is reserved for use during maintenance of the first subset of the set of solid-state hydrogen batteries.

11. The method of claim 8, wherein each of the set of solid-state hydrogen batteries comprises a metal hydride.

12. The method of claim 11, wherein the metal hydride comprises one of lanthanum-nickel hydride, iron-titanium hydride, or sodium-aluminum hydride.

13. The method of claim 8, wherein each of the set of solid-state hydrogen batteries comprises hydrogen atoms bonded to a metal alloy.

14. A system comprising:
a hybrid battery system including a set of solid-state hydrogen batteries and a set of rechargeable batteries, wherein the hybrid battery system is to supply power to compute resources associated with a datacenter;
a set of fuel cells coupled with the hybrid battery system, wherein a respective solid-state hydrogen battery from among the set of solid-state hydrogen batteries is configured to supply hydrogen to the set of fuel cells, when heat is supplied to the respective solid-state hydrogen battery; and
a power control system, coupled to the hybrid battery system and the set of fuel cells, wherein the power control system is configured to:
during a short-term outage associated with the datacenter, selectively cause a subset of the set of rechargeable batteries to supply power to the compute resources, and
during a long-term outage associated with the datacenter:
(1) selectively cause heat to be supplied to a first subset of the set of solid-state hydrogen batteries, resulting in the first subset of the set of solid-state hydrogen batteries supplying hydrogen to one or more of the set of fuel cells, allowing supply of power to the compute resources from the one or more of the set of fuel cells,
(2) selectively cause water and heat produced by the one or more of the set of fuel cells and-to flow to a first heat exchanger,
(3) selectively cause waste heat produced by the datacenter to flow to the first heat exchanger, and
(4) selectively cause the first heat exchanger to provide heat to the hybrid battery system to help heat the first subset of the set of solid-state hydrogen batteries.

15. The system of claim 14, wherein the power control system is further configured to: (1) selectively cause heated water to flow from the one or more of the set of fuel cells to a second heat exchanger, (2) selectively cause the second heat exchanger to provide cooled water for use with a cooling system associated with the datacenter, and (3) selectively cause the second heat exchanger to provide heat to a direct air capture system.

16. The system of claim 14, wherein only the first subset of the set of solid-state hydrogen batteries is configured to supply hydrogen during the long-term outage, and wherein a second subset of the set of solid-state hydrogen batteries is reserved for use during maintenance of the first subset of the set of solid-state hydrogen batteries.

17. The system of claim 14, wherein each of the set of solid-state hydrogen batteries comprises a metal hydride.

18. The system of claim 17, wherein the metal hydride comprises one of lanthanum-nickel hydride, iron-titanium hydride, or sodium-aluminum hydride.

19. The system of claim 14, wherein each of the set of solid-state hydrogen batteries comprises hydrogen atoms bonded to a metal alloy.

20. The system of claim 14, wherein the power control system is configured to predict utilization load of the compute resources to allow for maintenance associated with the set of solid-state hydrogen batteries during time periods associated with a lower predicted utilization load of the computer resources in the datacenter.
